(19) United States
(12) Patent Application Publication
(10) Pub. No.: US 2025/0211697 A1
(43) Pub. Date: Jun. 26, 2025

(54) COMMUNICATION DEVICE AND NON-TRANSITORY COMPUTER-READABLE RECORDING MEDIUM STORING COMPUTER-READABLE INSTRUCTIONS FOR COMMUNICATION DEVICE

(71) Applicant: BROTHER KOGYO KABUSHIKI KAISHA, Nagoya (JP)

(72) Inventor: Satoshi SUZUKI, Nagoya (JP)

(21) Appl. No.: 18/989,820

(22) Filed: Dec. 20, 2024

(30) Foreign Application Priority Data
Dec. 25, 2023 (JP) 2023-218184

(51) Int. Cl. H04N 1/32; H04N 1/00

(52) U.S. Cl. CPC H04N 1/32673; H04N 1/00896; H04N 1/00925; H04N 1/32683

(57) ABSTRACT

A communication device includes a first controller, a second controller which consumes less power than the first controller, and a memory configured to store a first setting value and a second setting value. The communication device is configured to operate selectively in one of a plurality of operation modes including a second operation mode in which the second controller can execute a process without the first controller executing the process. The second controller is configured to, in a case where the function executing instruction is received from the external device, the first setting value indicates the first value corresponding to executing the predetermined function, and the second setting value indicates the fourth value corresponding to not executing the process in a situation where the operation mode is the second operation mode, execute a related process related to not executing the predetermined function with the second operation mode maintained.

### REFERENCE TO RELATED APPLICATIONS

This application claims priority from Japanese Patent Application No. 2023-218184 filed on Dec. 25, 2023. The entire content of the priority application is incorporated herein by reference.

### BACKGROUND ART

A technology of filtering communication according to a firewall setting is known.

### SUMMARY

The present teachings provide an art configured to reduce power consumption of a communication device with a plurality of controllers.

A communication device is disclosed herein. The communication device may include: a first controller; a second controller which consumes less power than the first controller; and a memory configured to store a first setting value corresponding to a first setting item and a second setting value corresponding to a second setting item which is related to the first setting item and different from the first setting item, wherein the first setting value indicates either a first value corresponding to executing a predetermined function according to a function executing instruction received from an external device or a second value corresponding to not executing the predetermined function according to the function executing instruction, and the second setting value indicates either a third value corresponding to executing a process according to a signal received from an external device or a fourth value corresponding to not executing the process according to the signal. The communication device may be configured to operate selectively in one operation mode of a plurality of operation modes including a first operation mode in which the first controller is capable of executing a process and a second operation mode in which the second controller is capable of executing a process without the first controller executing the process. The second controller may be configured to, in a case where the function executing instruction is received from the external device, the first setting value indicates the first value, and the second setting value indicates the fourth value in a situation where the operation mode of the communication device is the second operation mode, execute a related process which is related to not executing the predetermined function according to the function executing instruction with the operation mode of the communication device maintained in the second operation mode.

According to the above configuration, in the case where the first setting value indicates the first value and the second setting value indicates the fourth value, that is, when the first setting value and the second setting value are not consistent, the second controller executes the related process with the operation mode of the communication device maintained in the second operation mode. Therefore, the second controller with low power consumption executes the related process without the first controller with high power consumption executing the process. Due to this, power consumption of the communication device including the plurality of controllers can be reduced.

Another communication device is also disclosed herein. In the communication device, the second controller may be configured to, in a case where the function executing instruction is received from the external device, the first setting value indicates the second value, and the second setting value indicates the third value in a situation where the operation mode of the communication device is the second operation mode, execute a related process which is related to not executing the predetermined function according to the function executing instruction with the operation mode of the communication device maintained in the second operation mode.

According to the above configuration, in the case where the first setting value indicates the second value and the second setting value indicates the third value, that is, when the first setting value and the second setting value are not consistent, the second controller executes the related process with the operation mode of the communication device maintained in the second operation mode. Accordingly, the second controller with low power consumption executes the related process without the first controller with high power consumption executing the process. Due to this, power consumption of the communication device including the plurality of controllers can be reduced.

The computer-readable instructions for the communication device, a non-transitory computer-readable recording medium storing the computer-readable instructions, and a method executed by the communication device are also novel and useful.

### BRIEF DESCRIPTION OF DRAWINGS

FIG. 1 shows a diagram of a communication system.

FIG. 2 shows a flowchart of processes executed by a printer.

FIG. 3 shows a sequence diagram for a specific case.

FIG. 4 shows a diagram for comparing controls between the present embodiment and a comparative example.

### DESCRIPTION

### First Embodiment

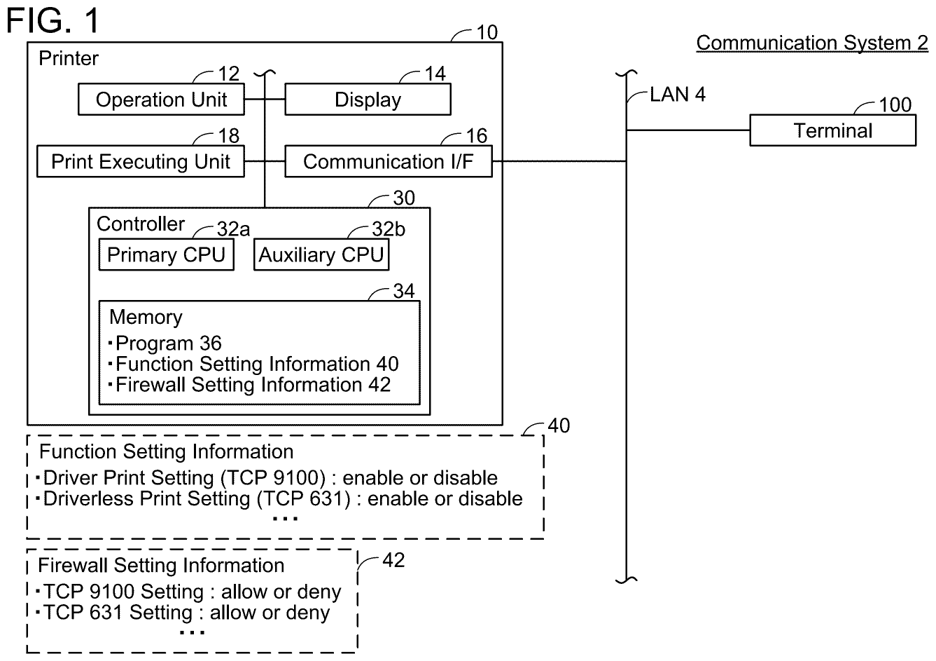

### (Configuration of Communication System 2; FIG. 1)

As shown in FIG. 1, a communication system 2 comprises a printer 10 and a terminal 100. The printer 10 and the terminal 100 are connected to each other via a Local Area Network (LAN) 4. The LAN 4 may be a wireless LAN or a wired LAN.

### (Configuration of Printer 10)

The printer 10 is a peripheral device capable of executing a printing function, e.g., a peripheral device of the terminal 100. In a modification, the printer 10 may be a multifunction peripheral capable of executing a scanning function, a facsimile function, etc., in addition to the printing function. The printer 10 comprises an operation unit 12, a display 14, a communication interface 16, a print executing unit 18, and a controller 30. Each of the units 12 to 30 is connected to a bus line. In the following, the interface will be described as “I/F”.

The operation unit 12 is an I/F that allows a user to input various information to the printer 10, and comprises for example, a touch screen and/or button(s). The user can input various information to the printer 10 via the operation unit 12. The display 14 is a display for displaying various information. The communication I/F 16 is connected to the LAN 4. The print executing unit 18 comprises a printing mechanism, such as an inkjet, laser, or thermal system.

The controller 30 comprises a primary CPU 32a, an auxiliary CPU 32b, and a memory 34. The memory 34 comprises a primary storage and an auxiliary storage. The primary storage includes, for example, a RAM and cache memory. The auxiliary storage may be, for example, a flash memory, a Solid State Drive (SSD), or a ROM, or a combination thereof. The program 36 is stored in the auxiliary storage. Each CPU 32a, 32b realizes various processes according to the program 36 loaded from the auxiliary storage to the primary storage.

Processing capacity of the primary CPU 32a is greater than that of the auxiliary CPU 32b. More specifically, for example, a clock frequency of the primary CPU 32a is greater than that of the auxiliary CPU 32b. Generally, the higher the processing capacity of a CPU, the higher power consumption of the CPU. Due to this, the power consumption of the primary CPU 32a is greater than that of the auxiliary CPU 32b.

Since the auxiliary CPU 32b has less processing capacity than the primary CPU 32a, the auxiliary CPU 32b is capable of executing only some of the various processes that the printer 10 is capable of executing. For example, the auxiliary CPU 32b is incapable of having the print executing unit 18 perform printing in accordance with a print instruction. For example, the auxiliary CPU 32b is capable of executing processes with relatively low processing load, such as monitoring of a signal from outside and sending a response signal to a status confirmation signal according to Simple Network Management Protocol (SNMP).

In the printer 10, the primary CPU 32a and the auxiliary CPU 32b operate selectively. That is, each process of the printer 10 is realized with one of the primary CPU 32a and the auxiliary CPU 32b on and the other off. In this embodiment, “CPU (is) on” means that the CPU is energized, and “CPU (is) off” means that the CPU is not energized. In a modification, “CPU (is) off” may mean that the CPU is energized but execution of a process by the CPU is prohibited.

The printer 10 is configured to operate selectively in one operation mode of a plurality of operation modes, including a normal mode and a power-saving mode. Power consumption of the power-saving mode is less than that of the normal mode. For example, the printer 10 shifts from the normal mode to the power-saving mode when the printer 10 continues not to execute any process for a predetermined period of time. In the normal mode, the primary CPU 32a is on and the auxiliary CPU 32b is off. In the power-saving mode, the auxiliary CPU 32b is on and the primary CPU 32a is off. Although this is not limiting, the display 14 may be lighted in the normal mode and the display 14 may not be lighted in the power-saving mode.

The memory 34 further stores function setting information 40 and firewall setting information 42. The function setting information 40 stores a function setting value for each of the various functions that the printer 10 is capable of executing. The function setting value indicates either “enable” which corresponds to executing the function according to a function executing instruction, or “disable” which corresponds to not executing the function according to the function executing instruction. In addition, a port number is designated for each function.

Specifically, the function setting information 40 includes a driver print setting (TCP9100) and a driverless print setting (TCP631). The driver print setting (TCP9100) is a print setting to which a port number TCP9100 is associated. The “enable” in the driver print setting (TCP9100) indicates executing printing according to a driver print instruction that includes the port number TCP9100 as a destination port number. The “disable” in the print setting (TCP9100) indicates not executing printing according to the driver print instruction that includes the port number TCP9100 as the destination port number. The driverless print setting (TCP631) is the same as the driver print setting (TCP9100) except that the port number is different.

Here, “driver printing” and “driverless printing” will be described. The “driver printing” means, for example, printing according to a print instruction generated in accordance with a program installed in an external device (e.g., terminal device 100) and provided by a vendor of the printer 10 (hereinafter referred to as “printer driver”). “Driverless printing” means printing according to a print instruction generated by a program that is different from the printer driver and that is embedded in an OS program of an external device (e.g., terminal 100).

The firewall setting information 42 stores a firewall setting value for each port number. The firewall setting value indicates either “allow”, which corresponds to executing a process according to a signal that includes a port number corresponding to that setting value as the destination port number, or “deny”, which corresponds to not executing a process according to that signal. The firewall setting information 42 includes a TCP9100 setting and a TCP631 setting. “allow” in the TCP9100 setting indicates executing a process (i.e., printing) according to a signal that includes the port number TCP9100 as the destination port number (i.e., a print instruction). “deny” in the TCP9100 setting indicates not executing the process according to the signal that includes the port number TCP9100 as the destination port number. The TCP631 setting is the same as the TCP9100 setting except that the port number is different.

### (Configuration of Terminal 100)

The terminal 100 is a mobile terminal device such as a cell phone, a smart phone, a PDA, a tablet PC, etc. In a modification, the terminal 100 may be a stationary PC, a laptop PC, etc. The terminal 100 in this embodiment is a device from which the driver print instruction and a driverless print instruction are sent.

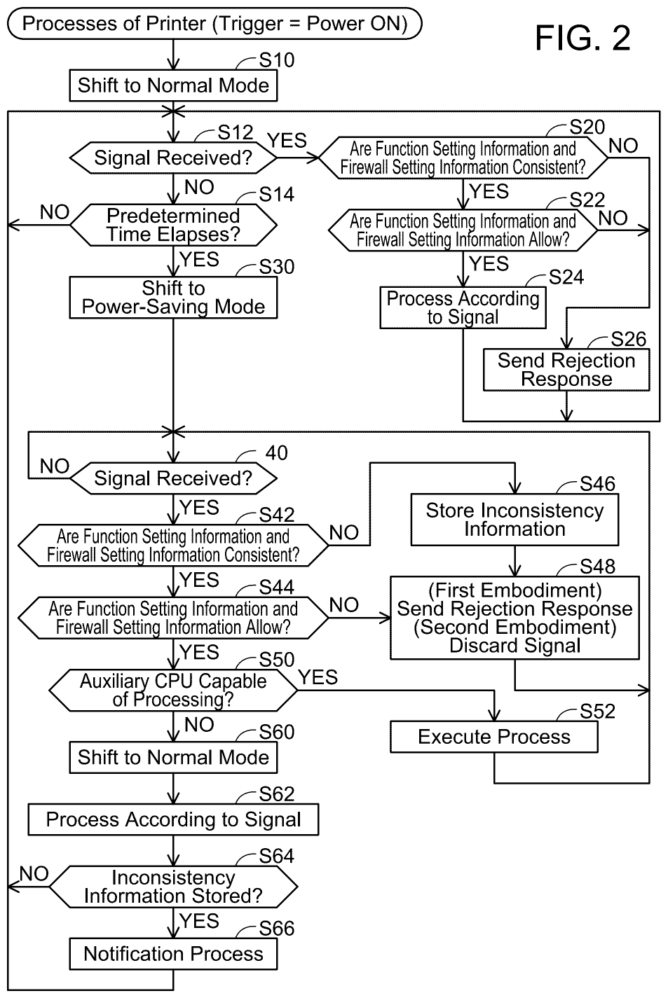

### (Processes of Printer; FIG. 2)

Referring to FIG. 2, processes realized by each CPU 32a, 32b of the printer 10 executing the program 36 will be described. The processes in FIG. 2 are started with a trigger of power of the printer 10 being turned on.

When the printer 10 receives a power-on operation from the user (trigger in FIG. 2), in S10 the printer 10 operates in the normal mode. This energizes the primary CPU 32a.

In S12, the primary CPU 32a monitors reception of a signal from an external device (e.g., terminal 100) via the communication I/F 16. The primary CPU 32a proceeds to S20 in a case where the signal is received (YES in S12), and proceeds to S14 in a case where the signal is not received (NO in S12).

In S14, the primary CPU 32a determines whether a predetermined time (e.g., 1 minute) has elapsed since a last event occurred. Here, an event includes receipt of a signal from the outside, operation on the operation unit 12 by the user, for example. The primary CPU 32a returns to monitoring of S12 in a case where the predetermined time has not elapsed (NO in S14), and proceeds to S30 in a case where the predetermined time has elapsed (YES in S14).

In S20, the primary CPU 32a determines whether the function setting information 40 and the firewall setting information 42 are consistent with each other for the signal already received in S12. Specifically, first, the primary CPU 32a specifies the destination port number (hereinafter described as “target port number”) included in the received signal. Next, the primary CPU 32a specifies the function setting value corresponding to the target port number from the function setting information 40 and the firewall setting value corresponding to the target port number from the firewall setting information 42. For example, in a case where the target port number is TCP9100, the primary CPU 32a specifies the function setting value (i.e., “enable” or “disable”) for the driver print setting (TCP9100) and specifies the firewall setting value (“allow” or “deny”) for the TCP9100 setting. Then, in a case where the specified function setting value indicates “enable” and the specified firewall setting value indicates “allow”, or in a case where the specified function setting value indicates “disable” and the specified firewall setting value indicates “deny”, the primary CPU 32a determines that both information 40, 42 are consistent (YES in S20) and proceeds to S22. Contrary to this, in a case where the specified function setting value indicates “enable” and the specified firewall setting value indicates “deny”, or in a case where the specified function setting value indicates “disable” and the specified firewall setting value indicates “allow”, the primary CPU 32a determines that both information 40, 42 are not consistent (NO in S20) and proceeds to S26.

In S22, the primary CPU 32a determines whether both the specified function setting value and the specified firewall setting value are values that allow the function to be executed. Specifically, in the case where the specified function setting value indicates “enable” and the specified firewall setting value indicates “allow,” the primary CPU 32a determines YES in S22 and proceeds to S24. Contrary to this, in the case where the specified function setting value indicates “disable” and the specified firewall setting value indicates “deny”, the primary CPU 32a determines NO in S22 and proceeds to S26.

In S24, the primary CPU 32a executes the process according to the signal received in S12. For example, in a case where the signal received in S12 is the driver print instruction, the primary CPU 32a causes the print executing unit 18 to print an image represented by image data included in the driver print instruction. When the process of S24 ends, the primary CPU 32a returns to the monitoring of S12.

In S26, the primary CPU 32a sends, via the communication I/F 16, a rejection response indicating not executing the process according to the instruction in the signal received in S12 to the external device from which the signal was sent. In a modification, the primary CPU 32a may discard the received signal in S26 without sending the rejection response. In another modification, if NO was determined in S20, the primary CPU 32a may, in S26, in addition to or instead of sending the rejection response or discarding the received signal, notify the user that the process according to the instruction in the signal was not executed due to between the function setting value and the firewall setting value being inconsistent. After the process of S26 ends, the primary CPU 32a returns to the monitoring of S12.

In S30, the primary CPU 32a shifts the operation mode of the printer 10 from the normal mode to the power-saving mode. Specifically, the primary CPU 32a first turns on the auxiliary CPU 32b by energizing the auxiliary CPU 32b. Thereafter, the primary CPU 32a is turned off to complete the transition to the power-saving mode. As a result, various subsequent processes are executed by the auxiliary CPU 32b.

In S40, the auxiliary CPU 32b monitors reception of a signal from an external device (e.g., terminal 100) via the communication I/F 16. In a case where the signal is received (YES in S40), the auxiliary CPU 32b proceeds to S42 and in a case where the signal is not received (NO in S12), the auxiliary CPU 32b returns to the monitoring of S40.

In S42, the auxiliary CPU 32b determines whether the function setting information 40 and the firewall setting information 42 are consistent with each other for the signal received in S40. The specific processes are the same as the process in S20, except that the subject of action of the process is the auxiliary CPU 32b instead of the primary CPU 32a. The process of S44 is also the same as the process of S22, except that the subject of action of the process is the auxiliary CPU 32b instead of the primary CPU 32a.

In S46, the auxiliary CPU 32b stores inconsistency information in the memory 34. The inconsistency information indicates that the process according to the instruction in the signal was not executed due to the function setting value and the firewall setting value being inconsistent for the signal received in S40. The auxiliary CPU 32b is configured incapable of executing a process of notifying the user of the inconsistency information. For this reason, as will be described in detail later, the process of notifying the user of the inconsistency information is executed by the primary CPU 32a after the printer 10 has been shifted to the normal mode. To realize such a handover to the primary CPU 32a, the auxiliary CPU 32b executes the process of S46.

In S48, the auxiliary CPU 32b sends, via the communication I/F 16, the rejection response indicating not executing the process according to the instruction in the signal received in S40 to the external device from which the signal was sent. That is, the auxiliary CPU 32b sends the rejection response to the external device without turning on the primary CPU 32a. In other words, the printer 10 sends the rejection response to the external device with the operation mode of the printer 10 maintained in the power-saving mode. After the process of S48 ends, the auxiliary CPU 32b returns to the monitoring of S40.

In S50, the auxiliary CPU 32b determines whether the auxiliary CPU 32b itself is capable of executing the process according to the instruction in the signal received in S40. A list of processes that the auxiliary CPU 32b is capable of executing is stored in advance in the memory 34. For example, the sending of a response signal to a status confirmation signal according to SNMP can be executed by the auxiliary CPU 32b, and a list indicating this is stored in the memory 34. In a case where the process according to the instruction in the received signal is indicated in the above list, the auxiliary CPU 32b determines YES in S50 and proceeds to S52. Contrary to this, in a case where the process according to the instruction in the received signal is not indicated in the above list, the auxiliary CPU 32b determines NO in S50 and proceeds to S60. In S52, the auxiliary CPU 32b executes the process according to the instruction in the signal received in S40. For example, in a case where the signal received in S40 is a status confirmation signal according to SNMP, the auxiliary CPU 32b sends a response signal via the communication I/F 16 to the external device from which the confirmation signal was sent. After the process of S52 ends, the auxiliary CPU 32b returns to the monitoring of S40.

In S60, the auxiliary CPU 32b shifts the operation mode of the printer 10 from the power-saving mode to the normal mode. Specifically, the auxiliary CPU 32b first turns on the primary CPU 32a by energizing the primary CPU 32a. Next, the auxiliary CPU 32b hands over the signal received in S40 to the primary CPU 32a. The auxiliary CPU 32b is then turned off to complete the transition to the normal mode. As a result, various subsequent processes are executed by the primary CPU 32a.

In S62, the primary CPU 32a executes the process according to the instruction in the signal obtained from the auxiliary CPU 32b (i.e., the signal already received by the auxiliary CPU 32b in S40).

In S64, the primary CPU 32a determines whether the inconsistency information (see S46) is already stored in the memory 34. The primary CPU 32a proceeds to S66 in a case where the inconsistency information is already stored in the memory 34 (YES in S64), and returns to the monitoring of S12 in a case where the inconsistency information is not stored in the memory 34 (NO in S64).

In S66, the primary CPU 32a executes a notification process to notify the user of the inconsistency information. For example, the primary CPU 32a displays the inconsistency information on the display 14 of the printer 10. As a result, the user can acknowledge that the process was not executed due to the function setting value and the firewall setting value being inconsistent while the printer 10 operated in the power-saving mode. The inconsistency information may be deleted from the memory 34 after the process of S66 has ended. After the process of S66 ends, the primary CPU 32a returns to the monitoring of S12.

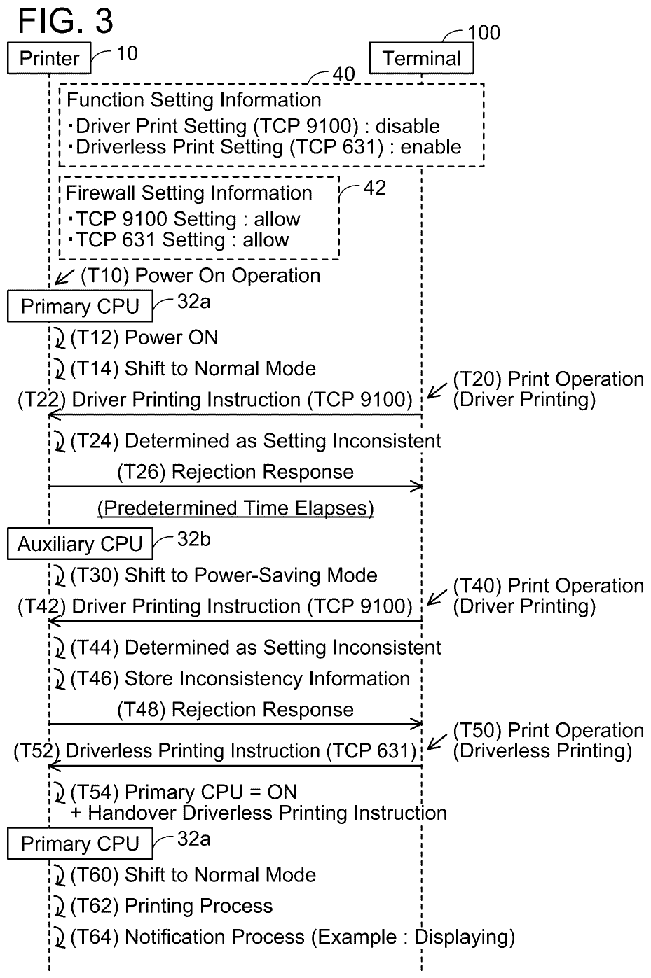

### (Specific Case; FIG. 3)

With reference to FIG. 3, a specific case realized by the processes in FIG. 2 will be described. Hereafter, processes executed by the CPU of the terminal 100 (not shown in the figures) will be described below, for ease of understanding, without describing the CPU as the subject of action of process but with the terminal 100 described as a subject of action of process. In addition, communication between the respective devices is executed via a communication I/F (e.g., 16). Therefore, in the following description, the recitation “via the communication I/F” will be omitted when communication is described.

In an initial state shown in FIG. 3, the function setting value for the driver print setting (TCP9100) indicates “disable” and the function setting value for the driverless print setting (TCP631) indicates “enable”. In addition, the firewall setting value for the TCP9100 setting and the firewall setting value for the TCP631 setting both indicate “allow”.

When the printer 10 receives a power-on operation from the user in T10, power of the printer 10 is turned on in T12 (trigger in FIG. 2). In this case, the printer 10 enters the normal mode in T14 by the primary CPU 32a of the printer 10 being energized (S10). That is, the subsequent processes are executed by the primary CPU 32a.

In T20, the terminal 100 receives a print operation for causing the printer 10 to execute driver printing from the user. The print operation is received from the user, for example, via the printer driver of the printer 10 installed in the terminal 100. In this case, in T22, the terminal 100 sends the driver print instruction to the printer 10. The driver print instruction includes port number TCP9100 as the destination port number.

In T22, the primary CPU 32a receives the driver print instruction from the terminal 100 (YES in S12). In this case, because the function setting value of the print setting (TCP9100) is “disable” and the firewall setting value of the TCP9100 setting is “allow”, in T24 the primary CPU 32a determines that the function setting information 40 and the firewall setting information 42 are inconsistent with each other (NO in S20). In this case, in T26, the primary CPU 32a sends the rejection response to the terminal 100 indicating not executing the process according to the driver print instruction (S26).

Then, a predetermined period of time elapses since the last event occurred (NO in S12, YES in S14). In this case, in T30 the printer 10 shifts to the power-saving mode (S30). That is, the printer 10 transitions to a state in which the primary CPU 32a is off and the auxiliary CPU 32b is on.

The process of T40 is the same as the process of T20. In T42, the auxiliary CPU 32b receives the driver print instruction that includes TCP9100 as the destination port number from the terminal 100 (YES in S40). In this case, since the function setting value of the driver print setting (TCP9100) is “disable” and the firewall setting value of the TCP9100 setting is “allow”, in T44 the auxiliary CPU 32b determines that the function setting information 40 and the firewall setting information 42 are inconsistent (NO in S44). In this case, in T46, the auxiliary CPU 32b stores the inconsistency information (S46) and sends the rejection response to the terminal 100 (S48).

In T50, the terminal 100 receives the print operation for causing the printer 10 to execute driverless printing from the user. In this case, in T52, the terminal 100 sends the driverless print instruction to the printer 10. The driverless print instruction includes the port number TCP631 as the destination port number.

In T52, the auxiliary CPU 32b receives the driverless print instruction from the terminal 100 (YES in S40). In this case, the function setting value of the print setting (TCP631) is “enable” and the firewall setting value of the TCP631 setting is “allow” (NO in S42, YES in S44). As described above, the auxiliary CPU 32b is configured incapable of executing the print process according to the driverless print instruction (NO in S50). Therefore, in T54, the auxiliary CPU 32b turns on the primary CPU 32a by energizing the primary CPU 32a. Next, the auxiliary CPU 32b hands over the driverless print instruction received in T52 to the primary CPU 32a. The auxiliary CPU 32b is then turned off. As a result, in T60, the transition to the normal mode is completed (S60).

In T62, the primary CPU 32a causes the print executing unit 18 to execute printing according to the driverless print instruction obtained from the auxiliary CPU 32b (i.e., the driverless print instruction that was already received by the auxiliary CPU 32b in T52) (S62).

At this stage, the memory 34 has already stored the inconsistency information (T46, YES in S64). Therefore, in T64, the primary CPU 32a executes the notification process of displaying the inconsistency information on the display 14, for example (S66).

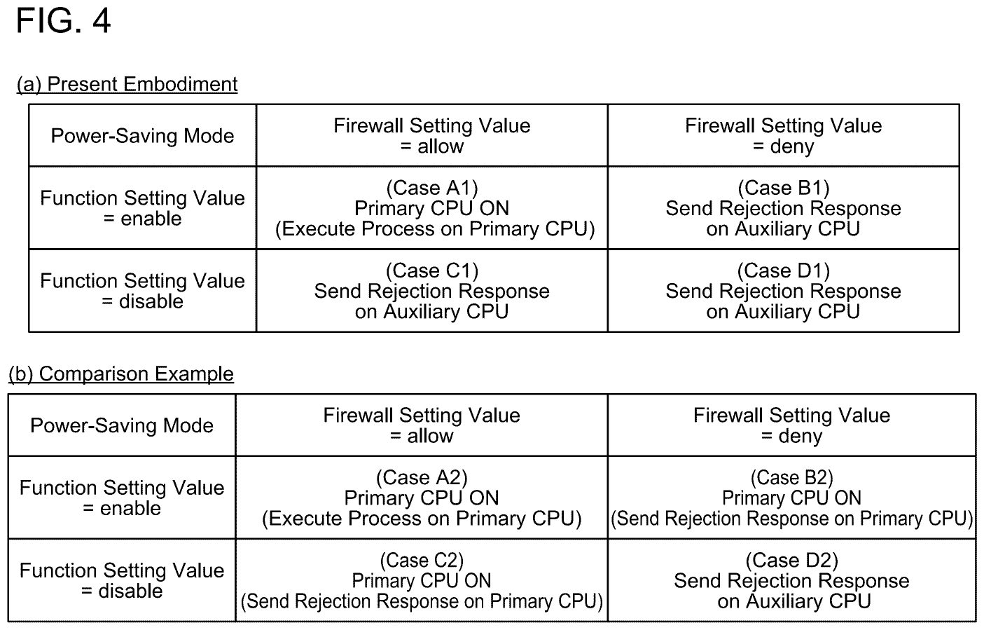

(Comparison between Present Embodiment and Comparative Example; FIG. 4)

Next, with reference to FIG. 4, differences between the printer 10 in this embodiment and the printer in a comparative example will be described. FIG. 4 (a) is a table showing the process when the printer 10 in this embodiment operates in the power-saving mode. FIG. 4 (b) is a table showing the process when the comparative example printer operates in the power-saving mode. Processes in a case where the function setting value and the firewall setting value are inconsistent (i.e., Cases B and C in FIG. 4) differ between the printer 10 in this embodiment and the printer in the comparative example. As described above, in the case where the function setting value and the firewall setting value are inconsistent in the situation where the printer 10 in this embodiment operates in the power-saving mode (i.e., cases B1 and C1 in FIG. 4 (a)), the auxiliary CPU 32b sends the rejection response without turning on the primary CPU 32a (NO in S42, S48 in FIG. 2). Contrary to this, in the case where the function setting value and the firewall setting value are inconsistent in the situation where the printer in the comparative example operates in the power-saving mode (i.e., cases B2 and C2 in FIG. 4 (b)), the auxiliary CPU 32b turns on the primary CPU 32a and shifts to the normal mode. As a result, the primary CPU 32a sends the rejection response.

As described above, in the case where the auxiliary CPU 32b receives a signal from the terminal 100 and the function setting value corresponding to the signal and the firewall setting value corresponding to the signal are inconsistent with each other (i.e., the combination of “enable” and “deny” (case B1 in FIG. 4 (a)) or the combination of “disable” and “allow” (case C1 in FIG. 4 (a))) in the situation where the printer 10 is in the power-saving mode, the auxiliary CPU 32b sends the rejection response to the terminal 100 with the operation mode of the printer 10 maintained in the power-saving mode. That is, in such a situation, the primary CPU 32a with high power consumption does not execute the process, but the auxiliary CPU 32b with low power consumption sends the rejection response. Accordingly, the power consumption of the printer 10 comprising the plurality of CPUs 32a, 32b can be reduced.

### (Correspondence Relationships)

The printer 10 and the terminal 100 are examples of “communication device” and an “external device,” respectively. The primary CPU 32a and the auxiliary CPU 32b are examples of “first controller (and first computer)” and “second controller (and second computer)”, respectively. The normal mode and the power-saving mode are examples of “first operation mode” and “second operation mode”, respectively. The print function and the driverless print function are examples of “predetermined function”. The port numbers TCP9100 and TCP631 are examples of “specific port number”. The print executing instruction is an example of “function executing instruction (and signal received from an external device) received from an external device”. The item corresponding to the function setting information 40 and the item corresponding to the firewall setting information 42 are examples of “first setting item” and “second setting item,” respectively. The function setting values “enable” and “disable” are examples of “first value” and “second value,” respectively. The firewall setting values “allow” and “deny” are examples of “third value” and “fourth value,” respectively. The process of sending the rejection response to a signal (S48 in FIG. 2) is an example of “related process”.

The process S46 in FIG. 2 is an example of the “store inconsistency information”. The process in S48 of FIG. 2 is an example of “in a case where the function executing instruction is received from the external device, the first setting value indicates the first value, and the second setting value indicates the fourth value in a situation where the operation mode of the communication device is the second operation mode, execute a related process (and in a case where the function executing instruction is received from the external device, the first setting value indicates the second value, and the second setting value indicates the third value in a situation where the operation mode of the communication device is the second operation mode, execute a related process).” The process of S66 in FIG. 2 is an example of the “notify a user of the inconsistency information”.

### Second Embodiment

Next, a second embodiment will be described. In the second embodiment, the process of S48 in FIG. 2 differs from the first embodiment. Specifically, in S48, the auxiliary CPU 32b discards the signal without executing the process according to the instruction in the signal received in S40, and without even sending the rejection response. This embodiment can also reduce power consumption of the printer 10 comprising the plurality of CPUs 32a, 32b. The process of discarding the signal (S48 in FIG. 2) is an example of “related process”.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

In each of the above embodiments, in a situation where the operation mode of the printer 10 is the power-saving mode, the auxiliary CPU 32b sends the rejection response with the power-saving mode maintained in both the first case where the function setting value indicates “enable” and the firewall setting value indicates “deny” and the second case where the function setting value indicates “disable” and the firewall setting value indicates “allow” (see S48 in FIG. 2 and FIG. 4). In a modification, the auxiliary CPU 32b may maintain the power-saving mode only in the first case and shift to the normal mode in the second case. In this modification, “in a case where the function executing instruction is received from the external device, the first setting value indicates the second value, and the second setting value indicates the third value in a situation where the operation mode of the communication device is the second operation mode, execute a related process” can be omitted. In another modification, the auxiliary CPU 32b may maintain the power-saving mode only in the second case and shift to the normal mode in the first case. In this modification, “in a case where the function executing instruction is received from the external device, the first setting value indicates the first value, and the second setting value indicates the fourth value in a situation where the operation mode of the communication device is the second operation mode, execute a related process” can be omitted.

(Modification 2) The auxiliary CPU 32b may not store the inconsistency information. That is, in the case where the auxiliary CPU 32b determines NO in S42 in FIG. 2, the auxiliary CPU 32b may skip the process of S46 and execute the process of S48. In this case, the primary CPU 32a can omit the processes of S64 and S66. Generally speaking, the “store inconsistency information” and the “notify a user of the inconsistency information” can be omitted.

(Modification 3) In the notification process of S66 in FIG. 2, the primary CPU 32a may send an e-mail including the inconsistency information to an e-mail address of an administrator registered in advance as its destination. In another modification, in the notification process of S66, the primary CPU 32a may send the inconsistency information to an external device (e.g., terminal 100) in response to the external device accessing the printer 10 using a web server function of the printer 10. In this modification, the terminal 100 is an example of “specific device”. The notification process is not limited to the forms of the above embodiments and this modification, but may be any other process for notifying the user of the inconsistency information.

(Modification 4) In the above embodiment, for example, the port number for printing is TCP9100, and the port number is invariable. On the other hand, there may be cases where a communication protocol is the same but the port number is variable. This has a range of port numbers called dynamic port or private port (e.g., 49152 to 65535). In a modification, the first setting value and the second setting value may be setting values corresponding to function executing instructions (or signals) that include different port numbers as destination port numbers from each other. Generally speaking, each of the “first value,” “second value,” “third value,” and “fourth value” may not include a specific port number as the destination port number.

(Modification 5) In the above embodiments, the process of each step in FIGS. 2 and 3 is realized by software (e.g., program 36), but at least one of these processes may be realized by hardware such as logic circuitry.

What is claimed is:

1. A communication device, comprising:
a first controller;
a second controller which consumes less power than the first controller; and
a memory configured to store a first setting value corresponding to a first setting item and a second setting value corresponding to a second setting item which is related to the first setting item and different from the first setting item, wherein the first setting value indicates either a first value corresponding to executing a predetermined function according to a function executing instruction received from an external device or a second value corresponding to not executing the predetermined function according to the function executing instruction, and the second setting value indicates either a third value corresponding to executing a process according to a signal received from an external device or a fourth value corresponding to not executing the process according to the signal,
wherein the communication device is configured to operate selectively in one operation mode of a plurality of operation modes including a first operation mode in which the first controller is capable of executing a process and a second operation mode in which the second controller is capable of executing a process without the first controller executing the process, and
the second controller is configured to, in a case where the function executing instruction is received from the external device, the first setting value indicates the first value, and the second setting value indicates the fourth value in a situation where the operation mode of the communication device is the second operation mode, execute a related process which is related to not executing the predetermined function according to the function executing instruction with the operation mode of the communication device maintained in the second operation mode.

2. The communication device as in claim 1,
wherein the second controller is further configured to, in a case where the function executing instruction is received from the external device, the first setting value indicates the second value, and the second setting value indicates the third value in a situation where the operation mode of the communication device is the second operation mode, execute the related process with the operation mode of the communication device maintained in the second operation mode.

3. The communication device as in claim 1,
wherein the related process includes sending a response signal to the external device, the response signal indicating that it is incapable of executing the predetermined function according to the function executing instruction.

4. The communication device as in claim 1,
wherein the related process includes discarding the function executing instruction without executing the predetermined function according to the function executing instruction.

5. The communication device as in claim 1,
wherein the second controller is further configured to store inconsistency information indicating that the first setting value and the second setting value are inconsistent in the memory, in a case where the related process is executed,
wherein the first controller is further configured to notify a user of the inconsistency information, in a case where the inconsistency information is being stored in the memory after the operation mode of the communication device has shifted from the second operation mode to the first operation mode.

6. The communication device as in claim 5,
wherein the first controller is configured to notify the user of the inconsistency information by executing at least one of:
displaying the inconsistency information on a display of the communication device;
sending an email including the inconsistency information; and
sending the inconsistency information to a specific device in response to the specific device accessing the communication device by using a web server function of the communication device.

7. The communication device as in claim 1,
wherein the first value is a value corresponding to executing the predetermined function according to the function executing instruction which includes a specific port number as a destination port number,
the second value is a value corresponding to not executing the predetermined function according to the function executing instruction which includes the specific port number as a destination port number,
the third value is a value corresponding to executing the process according to the signal which includes the specific port number as a destination port number, and
the fourth value is a value corresponding to not executing the process according to the signal which includes the specific port number as a destination port number.

8. A communication device, comprising:
a first controller;
a second controller which consumes less power than the first controller; and
a memory configured to store a first setting value corresponding to a first setting item and a second setting value corresponding to a second setting item which is related to the first setting item and different from the first setting item, wherein the first setting value indicates either a first value corresponding to executing a predetermined function according to a function executing instruction received from an external device or a second value corresponding to not executing the predetermined function according to the function executing instruction, and the second setting value indicates either a third value corresponding to executing a process according to a signal received from an external device or a fourth value corresponding to not executing the process according to the signal,
wherein the communication device is configured to operate selectively in one operation mode of a plurality of operation modes including a first operation mode in which the first controller is capable of executing a process and a second operation mode in which the second controller is capable of executing a process without the first controller executing the process, and
the second controller is configured to, in a case where the function executing instruction is received from the external device, the first setting value indicates the second value, and the second setting value indicates the third value in a situation where the operation mode of the communication device is the second operation mode, execute a related process which is related to not executing the predetermined function according to the function executing instruction with the operation mode of the communication device maintained in the second operation mode.

9. The communication device as in claim 8,
wherein the related process includes sending a response signal to the external device, the response signal indicating that it is incapable of executing the predetermined function according to the function executing instruction.

10. The communication device as in claim 8,
wherein the related process includes discarding the function executing instruction without executing the predetermined function according to the function executing instruction.

11. The communication device as in claim 8,
wherein the second controller is further configured to store inconsistency information indicating that the first setting value and the second setting value are inconsistent in the memory, in a case where the related process is executed,
wherein the first controller is further configured to notify a user of the inconsistency information, in a case where the inconsistency information is being stored in the memory after the operation mode of the communication device has shifted from the second operation mode to the first operation mode.

12. The communication device as in claim 11,
wherein the first controller is configured to notify the user of the inconsistency information by executing at least one of:
displaying the inconsistency information on a display of the communication device;
sending an email including the inconsistency information; and
sending the inconsistency information to a specific device in response to the specific device accessing the communication device by using a web server function of the communication device.

13. The communication device as in claim 8,
wherein the first value is a value corresponding to executing the predetermined function according to the function executing instruction which includes a specific port number as a destination port number,
the second value is a value corresponding to not executing the predetermined function according to the function executing instruction which includes the specific port number as a destination port number,
the third value is a value corresponding to executing the process according to the signal which includes the specific port number as a destination port number, and
the fourth value is a value corresponding to not executing the process according to the signal which includes the specific port number as a destination port number.

14. A non-transitory computer-readable recording medium storing computer-readable instructions for a communication device,
wherein the communication device comprises:
a first processor;
a second processor which consumes less power than the first processor; and
a memory configured to store a first setting value corresponding to a first setting item and a second setting value corresponding to a second setting item which is related to the first setting item and different from the first setting item, wherein the first setting value indicates either a first value corresponding to executing a predetermined function according to a function executing instruction received from an external device or a second value corresponding to not executing the predetermined function according to the function executing instruction, and the second setting value indicates either a third value corresponding to executing a process according to a signal received from an external device or a fourth value corresponding to not executing the process according to the signal,
wherein the communication device is configured to operate selectively in one operation mode of a plurality of operation modes including a first operation mode in which the first controller is capable of executing a process and a second operation mode in which the second controller is capable of executing a process without the first controller executing the process, and
the computer-readable instructions, when executed by the second processor, cause the communication device to, in a case where the function executing instruction is received from the external device, the first setting value indicates the first value, and the second setting value indicates the fourth value in a situation where the operation mode of the communication device is the second operation mode, execute a related process which is related to not executing the predetermined function according to the function executing instruction with the operation mode of the communication device maintained in the second operation mode.

15. A non-transitory computer-readable recording medium storing computer-readable instructions for a communication device,
wherein the communication device comprises:
a first processor;
a second processor which consumes less power than the first processor; and
a memory configured to store a first setting value corresponding to a first setting item and a second setting value corresponding to a second setting item which is related to the first setting item and different from the first setting item, wherein the first setting value indicates either a first value corresponding to executing a predetermined function according to a function executing instruction received from an external device or a second value corresponding to not executing the predetermined function according to the function executing instruction, and the second setting value indicates either a third value corresponding to executing a process according to a signal received from an external device or a fourth value corresponding to not executing the process according to the signal,
wherein the communication device is configured to operate selectively in one operation mode of a plurality of operation modes including a first operation mode in which the first controller is capable of executing a process and a second operation mode in which the second controller is capable of executing a process without the first controller executing the process, and
the computer-readable instructions, when executed by the second processor, cause the communication device to, in a case where the function executing instruction is received from the external device, the first setting value indicates the second value, and the second setting value indicates the third value in a situation where the operation mode of the communication device is the second operation mode, execute a related process which is related to not executing the predetermined function according to the function executing instruction with the operation mode of the communication device maintained in the second operation mode.
